(19) United States
(12) Patent Application Publication
(10) Pub. No.: US 2022/0205279 A1
(43) Pub. Date: Jun. 30, 2022

(54) Automatic Lock With Rotatable Trigger

(71) Applicant: Finn Locks Limited, Highbury (GB)

(72) Inventors: Timothy Christopher Finn, Highbury (GB); Andrew Martin Taylor, New Milton (GB)

(21) Appl. No.: 17/612,078

(22) PCT Filed: Jun. 2, 2020
(86) PCT No.: PCT/GB2020/000055

§ 371 Date: Nov. 17, 2021

(30) Foreign Application Priority Data
Jun. 6, 2019 (GB) 1908124.9

(51) Int. Cl. E05B 55/12; E05C 1/00; E05C 1/12; E05B 63/08; E05B 63/18; E05B 63/20

(52) U.S. Cl. CPC E05B 55/12; E05C 1/002; E05C 1/12; E05B 2015/0413; E05B 63/185; E05B 63/20; E05B 63/08

(57) ABSTRACT

A lock for securing to a movable body (1) and for cooperating with a strike plate (12) on a stationary body (11), which lock is movable away from the strike plate (12) for opening the movable body (11), which lock is movable into juxtaposition with the strike plate (12) for closing the movable body (11) and which lock comprises a casing (3) which includes a rotatable trigger (8) which is positioned in the casing (3) and a locking member (7) which is also positioned in the casing (3) and wherein; the rotatable trigger (8) projects from the casing (3); the rotatable trigger (8) rotates about an axis of rotation positioned on a front working plane of the casing (3) such that the rotatable trigger (8) rotates into the casing (3) and out of the casing (3) with the rotatable trigger (8) being spring biased to rotate out of the casing (3); the locking member (7) is movable between a projected position in which the locking member (7) projects from the casing (3) and a retracted position in which the locking member (7) is retracted into the casing (3); the locking member (7) is configured to move into the projected position when the rotatable trigger (8) rotates into the casing (3); the locking member (7) is configured to move into the retracted position when the rotatable trigger (8) rotates out of the casing (3); the locking member (7) moves into a locked position when the lock is brought into juxtaposition with the strike plate (12) such that the rotatable trigger (8) rotates into the casing (3) as it comes into juxtaposition with the strike plate (12), whereby the locking member (7) projects from the casing (3) such that the locking member (7) moves into a recess in the strike plate to lock the movable body (1) and: • when the lock is moved out of juxtaposition with the strike plate (12) the rotatable trigger (8) rotates out of the casing (3) and the locking member (7) moves into the retracted position.

This invention relates to a lock and, more especially, this invention relates to a lock for securing to a movable body and for cooperating with a strike plate on a stationary body. The movable body may be a door, in which case the stationary body will be a door frame. The movable body may alternatively be another type of movable body such for example as a lid or other closure member, in which case the stationary body may be a container or other type of stationary body. Locks for securing a movable body in the form of a door and for cooperating with a strike plate on a stationary body in the form of a door frame are well known.

The lock of the present invention may include an automatic locking mechanism such that the lock comprises a casing and a locking member which may move in and out of the casing. The lock may also include a rotatable auxiliary member in the form of a rotatable trigger which rotates in and out of the casing. The lock of the present invention may be an improved automatic lock which will achieve a locking effect between the movable body and the stationary body whereby the rotated position of the rotatable trigger is configured to control the movement of the locking member such that when the lock is brought into juxtaposition with the strike plate, the locking member will project into a recess in the strike plate. The lock improves upon existing automatic locks in that the position of the rotatable trigger controls the locking member such that when the movable body is not in juxtaposition with the strike plate the rotatable trigger will project from the casing such that the locking member will be retracted into the casing. A small rotation of the rotatable trigger may achieve a complete movement of the locking member into or out of the casing. The rotatable trigger may be configured such that its projection distance from the casing is minimised relative to the gap distance between the movable body and the stationary body and also such that the projection of the strike plate is minimised. The lock may take advantage of the dynamics of a rotatable trigger to reduce the movable body closure force. The lock may include unlocking mechanisms which can be used in conjunction with the lock.

Accordingly, in one non-limiting embodiment of the present invention, this invention relates to a lock and, more especially, this invention relates to a lock for securing to a movable body and for cooperating with a strike plate on a stationary body, which lock is movable away from the strike plate for opening the movable body, which lock is movable into juxtaposition with the strike plate for closing the movable body, and which lock comprises a casing which includes a rotatable trigger which is positioned in the casing and a locking member which is also positioned in the casing and wherein:

the rotatable trigger projects from the casing;

the rotatable trigger rotates about an axis of rotation positioned on a front working plane of the casing such that the rotatable trigger rotates into the casing and out of the casing with the rotatable trigger being spring biased to rotate out of the casing;

the locking member is movable between a projected position in which the locking member projects from the casing and a retracted position in which the locking member is retracted into the casing;

the locking member is configured to move into the projected position when the rotatable trigger rotates into the casing;

the locking member is configured to move into the retracted position when the rotatable trigger rotates out of the casing;

when the lock is brought into juxtaposition with the strike plate the rotatable trigger comes into juxtaposition with the strike plate such that the rotatable trigger rotates into the casing and the locking member moves into a locked position, whereby the locking member projects from the casing such that the locking member moves into a recess in the strike plate to lock the movable body; and

when the lock is moved out of juxtaposition with the strike plate the rotatable trigger rotates out of the casing and the locking member moves into the retracted position.

In contrast to known locks, the lock of the present invention is such that the locking member is configured to move into the retracted position when the rotatable trigger rotates out of the casing.

The lock in the present invention may be described as a balanced action automatic lock. This is because the relationship between the rotatable trigger and the locking member may be described as balanced such that the inward movement of the rotatable trigger gives a projection of the locking member to the locked position and the outwards movement of the rotatable trigger gives the retraction of the locking member to the unlocked position. Thus when the movable body is free of the stationary body, the locking member will never be left in the projected position. This balanced action allows for a lock which when free of the strike plate cannot be manipulated such as to be rendered unusable.

The balanced action also allows for a lock which cannot be rendered unusable by an abortive attempt at closure against the strike plate. Thus a balanced action lock gives a locking device which is much more reliable, especially if it is used in situations where the user may not have an understanding of the lock or situations where the user may take little care to make sure the movable body is locked to the stationary body.

There are known automatic locks which can be described as slam automatic locks and which may use triggering devices to release what is usually a spring biased locking member from a retracted position in a lock casing such that the locking member will project from a casing to achieve the locked position. Such triggering devices, once initiated, effect the release of the locking member to the locked position and the locking member needs to be retracted into the casing by a separate action, such as the user unlocking the lock with a key or handle. Such locks give for many occurrences of the locking member being released inappropriately such as when the movable body is free of the stationary body, and the user having to correct the position of the locking member. Such locks can allow for a gap between the movable body and the stationary body but this gap is not so critical to the security of the slam automatic locking device.

In a balanced action lock, achieving and maintaining a gap between the movable body and the stationary body, where no movement is required of the locking member is important. This is because, if this gap distance is exceeded, the rotatable trigger or sliding trigger will move further out of the casing to effect a retraction of the locking member and thus unlocking the locking member.

The dynamics of including a rotatable trigger in a balanced action lock are much more complex than including a rotatable trigger in a slam automatic lock. For instance, the triggering point of a slam automatic lock need only be met once during the locking process but a balanced action lock needs to maintain a maximum distance gap while the movable body is in the secured position and so additional tolerances need to be included for this.

The lock of the present invention may include a lock wherein the spring bias force which operates on the rotatable trigger to bias the rotatable trigger to rotate out of the casing, is such that the same spring bias force is also configured to force the locking member into the retracted position in the casing as the rotatable trigger rotates out of the casing, such that, when the lock is moved out of juxtaposition with the strike plate the rotatable trigger will be spring biased to rotate out of the casing and the locking member will be spring biased to move into the retracted position in the casing.

There is a spring biasing force required of the rotatable trigger to rotate the rotatable trigger out of the lock casing when the lock is free of the strike plate. This same spring force also acts to force the locking member to be retracted into the lock casing when the lock is free of the strike plate such that the locking member is never left projecting from the casing when the lock is free of the strike plate. This spring bias force needs to be balanced with the ability of the rotatable trigger to move the locking member out of the casing, which includes separate but additional spring forces such that the spring bias force needs to be sufficient to be reliable to retract the locking member to the unlocked position but not excessive when combined with additional spring forces that move the locking member out of the casing as these additional forces add to the movable body closure force.

Previous versions of locks which may be described as balanced action locks are US/2519808 A and WO/2015/000876 A. These previous versions disclose a sliding trigger instead of a rotatable trigger. Such sliding triggers slide along a ramp on a strike plate, thus attaining a backwards movement of the trigger into the lock casing to achieve the locking motion required within the lock casing to project the locking member from the casing. The length of projection from the casing and the design of such sliding triggers are largely dictated by the length of projection required of the locking member and the acceptable gap between the movable body and the stationary body.

With a balanced action automatic lock which has a sliding trigger, achieving a conventional length of projection of locking member, while achieving an acceptable gap requires a long projection of the sliding trigger from the casing. It also requires a deep ramp on the strike plate to enable the sliding motion of the sliding trigger. Such deep ramps can be unattractive in appearance and can look unconventional. Sliding triggers also require a large closure force to achieve the long sliding motion as considerable friction can occur between the sliding trigger and the ramp area of the strike plate.

The lock of the present invention may be one which includes a tumbler in the casing and wherein:
the tumbler is configured such that as the rotatable trigger rotates into the casing and the locking member projects out of the casing into a partially or fully projected position, the tumbler moves into a position in the casing such that it prevents the locking member from being forced into the casing by a force external of the casing being applied to the projected end of the locking member; and
the tumbler is also configured such that when the rotatable trigger rotates out of the casing and the locking member moves into the unlocked position in the casing, the tumbler moves out of a position where it prevents the locking member moving into the unlocked position.

The addition of the tumbler adds extra security to the locking facility, with the use of a rotatable trigger allowing the tumbler to be positioned earlier in the locking process such that a large gap between the movable body and the closure member is achieved where the tumbler acts to prevent the locking member from being forced back into the casing by unwanted interference to overcome the locking facility. For a balanced action automatic lock as described to work, the locking member typically needs to be free to move backwards in the lock casing when the rotatable trigger moves out of the casing (as when the lock is free of the strike plate and the rotatable trigger is rotated into the casing and then rotates out of the casing) and the tumbler is configured in the lock casing to move from the path of the locking member moving backwards in the casing while the rotatable trigger rotates out of the casing.

The lock in the present invention may be one in which the locking member is a locking bolt such that the front projecting plane of the locking bolt is orthogonal in form. A locking bolt would be more commonly described as a deadbolt and is largely considered more secure than, for instance, a latch bolt which has a curved front face.

The lock in the present invention may include a minimum angle of rotation of the rotatable trigger such that the minimum angle of rotation will achieve a full projection of the locking member such that:
when the lock comes into juxtaposition with the strike plate, there is a maximum gap distance between the front working plane of the casing and the corresponding face of the strike plate such as to allow for the minimum angle of rotation of the rotatable trigger to be achieved, and such that;
the maximum gap distance is a maximum measurement which still ensures a full projection of the locking member;
there is a projection distance, which is the distance the furthest point of the rotatable trigger projects beyond the front working plane of the casing when the rotatable trigger is fully rotated out of the casing; and
there is a relationship between the projection distance and the maximum gap distance such as to have a minimising effect on the required projection distance relative to the maximum gap distance.

With such a lock the rotatable trigger can be configured such that it minimises the projection distance relative to the maximum gap distance.

Slam automatic locks as described previously do not need to maintain a maximum distance gap while the movable body is secured to the stationary body. However, if a balanced action lock has not achieved the maximum distance gap, the locking member will be unsecured because the tumbler will not be in position to prevent the locking member being forced back by forces external to the lock casing. There are synergies between the rotatable trigger and the balanced action lock.

An advantage of a rotatable trigger over a sliding trigger is that the rotatable trigger may be configured such that a small rotation of the rotatable trigger can achieve all of the locking motion required within the lock casing. This small rotation of the rotatable trigger achieving all of the locking motion required will leave a relatively large gap between the strike plate and the lock where no rotation of the rotatable trigger is required, this gap being relatively large in comparison to the length of projection of the rotatable trigger from the casing that is required to achieve the gap, thus allows for a shorter projecting rotatable trigger than would otherwise be possible with a sliding trigger. This is especially so when long locking member projection lengths are desired.

For a balanced action lock with a sliding trigger, achieving modern locking member projection lengths requires a relatively long sliding trigger projection. A typical conventional lock may have a locking member which projects in excess of 20 mm from the casing. To achieve this projection in a balanced action lock with acceptable door closure forces would require a 15 mm projection of sliding trigger to achieve a 7 mm gap whereas a rotating trigger projection of 10 mm can achieve the same gap and projection length.

There are several other advantages of using a rotatable trigger including relatively shorter projection of rotatable trigger.

The rotatable trigger can be constructed to look more like a standard latch and thereby be much more conventional looking. Thus a lock case can be achieved which looks like a standard latch lock and feels on closure like a standard latch lock, is failsafe in use like a standard latch lock, but is of a much more enhanced security level than a standard latch lock. Also the shorter rotatable trigger looks less obtrusive that the longer sliding trigger. The shorter rotatable trigger is less likely to be accidentally collided with by a user of the movable body. The angled area of the strike plate which juxtaposes with a sliding or rotating trigger will be shaped to accept the action of the trigger moving against it and is known in the trade as the ramp area. The shorter rotatable trigger allows for a shorter and less aggressive ramp on the strike plate which looks more conventional than that required by a longer sliding trigger. A sliding trigger may require a ramp as deep as the projection distance of the sliding trigger to maintain an acceptable door closure force. Such strike plates with deep ramps are unsightly. Also a strike plate with a ramp to accommodate a sliding trigger may require significantly more modification of the stationary body to include such a strike plate than the strike plate which accommodates a rotating trigger.

The lock of the present invention may be one that includes a first spring in the casing which acts between the rotatable trigger and the locking member, and in which:
the first spring is configured such that as the rotatable trigger comes into juxtaposition with the strike plate, the rotatable trigger rotates into the casing such that a force is applied to the first spring which applies a force to the locking member to move the locking member out of the casing; and
the force applied to the locking member gradually increases as the rotatable trigger rotates into the casing.

The lock of the present invention maybe one in which the force applied to the first spring increases as the rotatable trigger rotates into the casing and the first spring may be further configured to act between the rotatable trigger and the locking member such as to reduce the force required to rotate the rotatable trigger during the latter stages of rotation of the rotatable trigger into the casing.

This further first spring configuration helps to reduce the accumulation of spring force in the lock casing such that the spring force build up is limited to the earlier part of the rotation of the rotatable trigger where the spring tension is most relevant but the later stages of rotation of the rotatable trigger do not continue to increase the build-up of spring force in the lock casing when such increasing forces are unnecessary. This reduction of spring force serves to reduce the door closure force, especially when the gap between the movable body and the stationary body is small such that the rotatable trigger will rotate further into the lock casing. This force reduction is enhanced as the rotating trigger may be configured such that a minimum rotation of the rotating trigger may lock the locking member and the force reduction configuration may come into effect earlier in the locking cycle to contribute to reduce the movable body closure force.

The lock of the present invention may be one which includes a driver and a second spring, and in which:
the driver is positioned behind the rotatable trigger such that the driver is forced backwards by the rotatable trigger into the casing by the engagement of the rotatable trigger with the strike plate; and
the driver being biased by the second spring in a forward direction to remain in contact with the rotatable trigger, thereby biasing the rotatable trigger to project from the casing;
the first spring is configured with the driver such that the backwards movement of the driver applies a force to the first spring which is configured to apply a force to the locking member to move the locking member to the projected position; and
the driver is configured with the locking member such that if the lock is moved out of juxtaposition with the strike plate, the second spring biases the driver in a forwards direction which spring biases the locking member into a retracted position in the casing.

The lock of the present invention may include a bolt link which rotates about a fixed fulcrum in the casing, and a spring arm which also rotates about the fixed fulcrum, and in which:
the rotation of the spring arm is such as to move the locking member between the projected position out of the casing and the retracted position into the casing;
the first spring is configured with the driver such that the backwards movement of the driver is configured to apply a force to the first spring which applies a force to the spring arm to rotate the spring arm to cause the locking member to move to the projected position;
the driver is configured with the bolt link such that a movement of the driver causes a rotation of the bolt link;
and as the lock is moved out of juxtaposition with the strike plate and the rotating trigger rotates out of the casing, the driver is spring biased forwards by the second spring;
the bolt link is configured with the spring arm such that a forwards movement of the driver causes a rotation of the bolt link which causes a rotation of the spring arm to move the locking member into the retracted position.

The lock may be one in which the first spring is a torsion spring which rotates about the fixed fulcrum, the first spring has a first leg and a second leg, the first leg is configured to move with the driver, the first leg is rotatable backwards by the driver and thereby to apply force to the second leg which is configured to put a rotational force on the spring arm to move the locking member to the projected position. The first spring need not be a torsion spring but a torsion spring is convenient.

The lock may be one in which the first spring is a torsion spring and together with the driver are configured such that when the driver is in the latter stages of its backwards movement, the driver slides over the first leg of the first spring, thus reducing the force required to rotate the rotatable trigger in the latter stages of its rotation into the casing. This reduction of spring force to reduce the force required to rotate the rotatable trigger serves to reduce the door closure force especially when the gap between the movable body and the stationary body is small such that the rotatable trigger will rotate further into the lock casing.

The lock may be one in which the tumbler is configured such that the rotation of the bolt link moves the tumbler into a position in the casing that prevents the locking member from being retracted into the casing by a force applied to the projected area of the locking member, the tumbler also being configured such that the opposite rotation of the bolt link moves the tumbler out of a position where the tumbler prevents the locking member moving into the unlocked position.

The lock may be one in which the rotatable trigger is configured to engage the strike plate, and the rotatable trigger rotates about a point of rotation, and in which:
the distance between the point of rotation and the point of contact of the rotatable trigger with the strike plate, is greater than the distance from the point of rotation to the contact point of the rotatable trigger with the driver, thereby creating a mechanical advantage to reduce the lateral force required to rotate the rotatable trigger against the strike plate to achieve a backwards movement of the driver during closure of the movable body.

The rotatable trigger also has mechanical advantages over the sliding trigger as the rotatable trigger rotates between the strike plate and the driver. The rotatable trigger may be configured to hit the strike plate which it rotates against and also configured with the driver such that the movable body lateral closing force transfers directly onto a point on the driver to achieve a mechanical advantage to reduce the movable body closing force. Reducing the movable body closing force allows for weaker forces within the lock casing which can enhance the reliability and longevity of the mechanism. Reducing the movable body closing force enables the movable body to be shut with less force and correspondingly less noise. It also enables more than one automatic lock to be fitted to the movable body.

The lock of the present invention may include a thrower in the casing and a thrower spring which is in the casing and which is connected to the thrower, and a user-operable mechanism which is interchangeable to the casing, and in which:
the user-operable mechanism is able to exert a force that moves the locking member from the locked position to the unlocked position;
the user-operable mechanism has a rotatable nib which is movable in an arc within the casing;
the thrower is movable in an arc within the casing, the arc being approximately concentric to the arc described by the rotatable nib;
the thrower spring is a torsion spring with one leg of the thrower spring mounted on a pivot in the casing and the other leg of the thrower spring pivoted on the thrower such that;
when a force is applied to the rotatable nib, the rotatable nib moves the thrower, the thrower being spring biased by the thrower spring so that when the force on the rotatable nib is released, the rotatable nib is spring biased to return to its original position prior to a force being applied to it; and
the thrower is configured to move the locking member to the unlocked position.

The user operable mechanism would typically be a key operated locking cylinder. The inclusion of a thrower in the casing reduces the rotation required to unlock the mechanism. It also gives greater control of the unlocking process while allowing for interchangeability of user operable mechanisms and thereby making the lock more versatile.

The thrower may allow a user operable mechanism such as a locking cylinder to be interchangeable to the lock but still enabling a spring correction facility to the unlocking process. This spring correction facility also enhances the unlocking movement by, for example, returning an unlocking key to its original insertion position such as the key can again be readily withdrawn from the user operable mechanism. The spring correction facility can also position the unlocking nib and the thrower such as the unlocking nib and the thrower will not impede the movement of the locking member.

The lock of the present invention may also include an unlocking assembly which is configured to move the locking member to the unlocked position. The unlocking assembly may include an interchangeable handle or such to be configured with the unlocking assembly such as to rotate the unlocking assembly. The configuration of the unlocking assembly may act to reduce the unlocking rotation angle required to unlock the locking member.

The unlocking assembly includes an unlocking barrel and an unlocking cam, the unlocking barrel being rotatable with the unlocking cam, and the unlocking barrel being rotatable to connect with the unlocking cam to rotate the unlocking cam which moves the locking member to the unlocked position. The lock may be such that with the locking member positioned in the casing where the unlocking member may collide with the unlocking cam during retraction of the locking member when the lock is free of the strike plate, the unlocking cam is configured to freely rotate during such a collision to move from the area of movement of the locking member such as not to impede the movement of the locking member. In situations where the user operable mechanism will be set close to the edge of the movable body it is necessary to accommodate the locking member colliding with the unlocking cam when the rotatable trigger is pressed and released such that the locking member is fully retracted into the lock casing.

The mechanisms described thus far in the invention do not rely on electric or battery power to drive the mechanisms such that the lock is described as a mechanical lock.

Embodiments of the invention will now be described solely by way of example and with reference to the accompanying drawings in which:

FIG. 1 is a section through a lock of the present invention with a lock case cover being removed to show the lock in a fully unlocked state when disengaged from a strike plate and with the strike plate immediately behind;

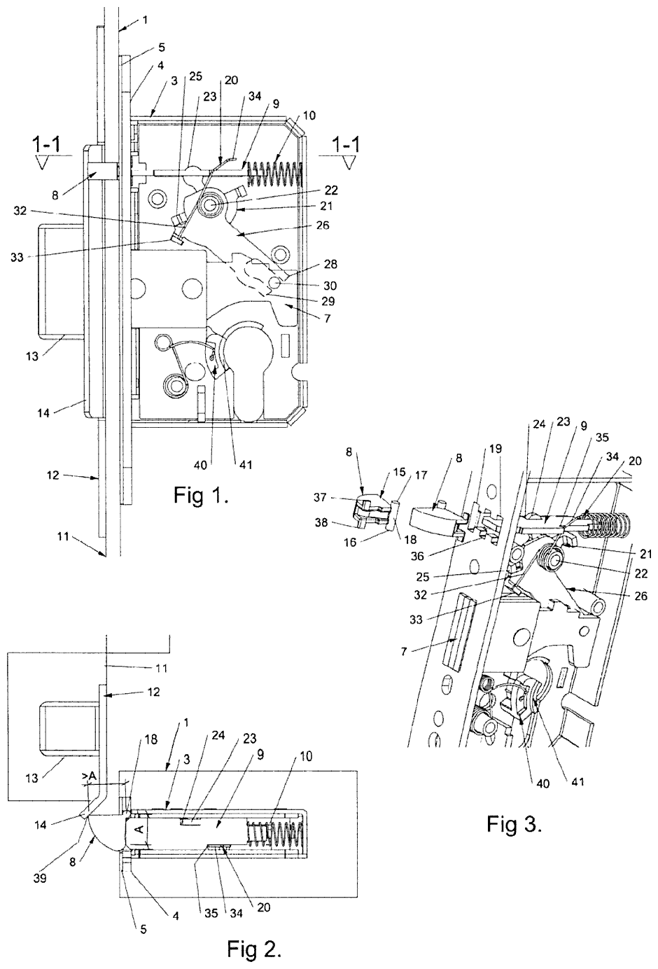

FIG. 2 is a plan section on the line 1-1, with component parts being shown in cross-section on a horizontal plane, and with the locking device being shown in an unlocked state and about to engage with the strike plate;

FIG. 3 is a three dimensional view of part of the front of the lock case, with an upper fore-end removed, and a rotatable trigger slightly removed from the lock and rotated to create a second view of the rotatable trigger to display the rear of the rotatable trigger;

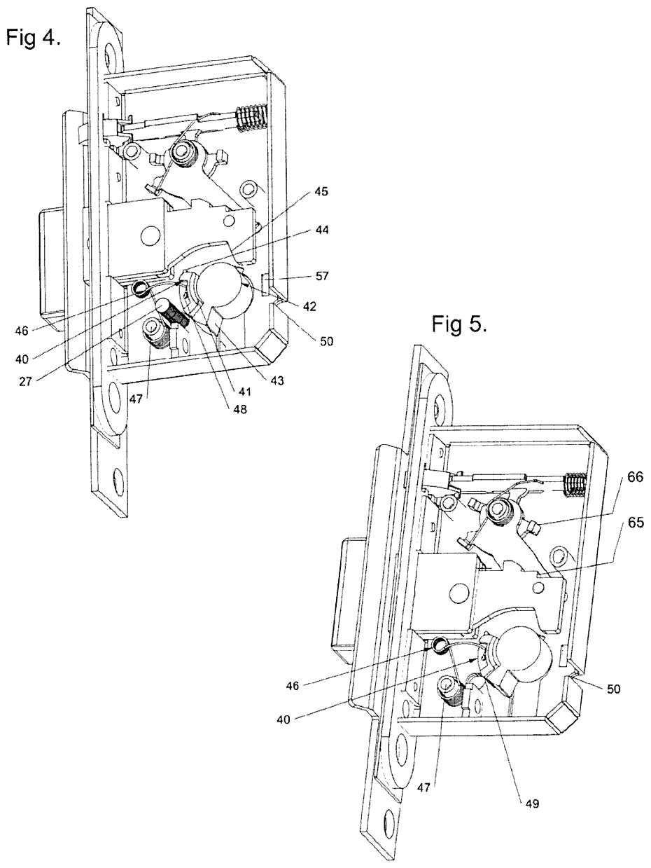

FIG. 4 is a three dimensional view of the lock casing, with an outer casing cover removed, with the lock casing coming into juxtaposition with the strike plate in the initial stages of a movable body closing situation;

FIG. 5 is a three dimensional view of the lock, with the outer lock casing cover removed, and with the lock casing in juxtaposition with the strike plate in the latter stages of a movable body closing situation;

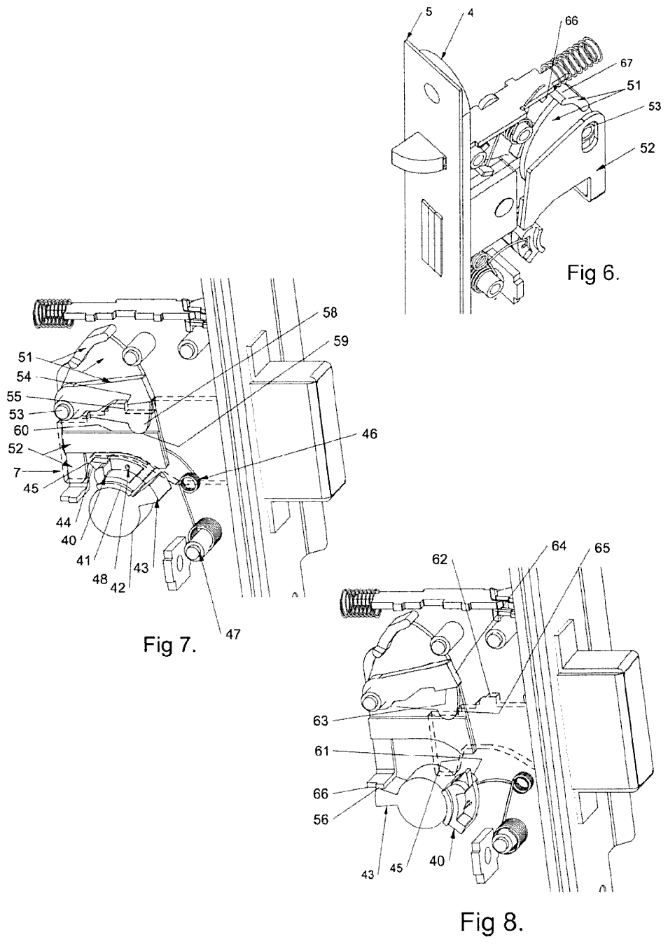

FIG. 6 is a three dimensional view of the lock, with the lock casing removed, and with two extra component members added to the lock casing which are not shown in previous Figures;

FIG. 7 is a three dimensional view of the lock casing looking into the lock casing in a direction opposite to the view shown in FIG. 6, and with the lock casing plus other component elements removed, and with the lock casing being positioned adjacent the strike plate in a movable body closed configuration where the lock would have been locked but then unlocked;

FIG. 8 is a three dimensional view similar to FIG. 7, but with the configuration of the lock being such that it has just been relocked by a relock facility;

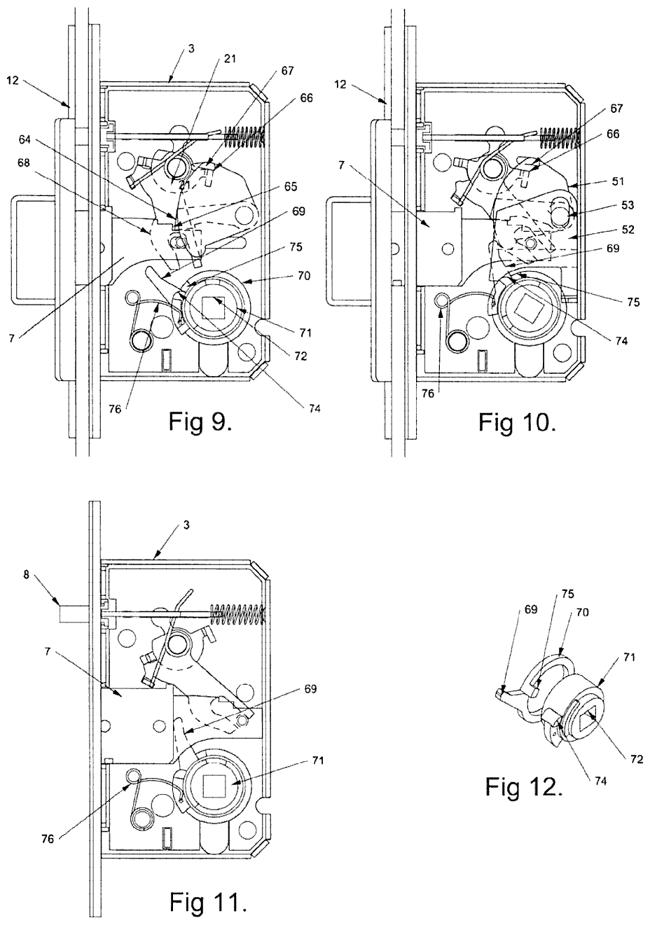

FIG. 9 is a section through a second lock of the present invention with a lock case cover being removed to show the lock in a fully locked state when engaged with the strike plate;

FIG. 10 is a view into the second lock of the present invention with a lock case cover being removed to show the lock in a partially unlocked state while engaging with the strike plate;

FIG. 11 is a view into the second lock of the present invention with a lock case cover being removed to show the lock in a fully unlocked state with some components removed to better demonstrate the unlocked state and the lock disengaged with the strike plate; and

FIG. 12 is a three dimensional view of an unlocking assembly of the second lock of the present invention.

Referring now to FIGS. 1-8, there is shown a first lock of the present invention fitted on a movable body 1 having a movable body edge 2. Each lock is contained in a lock casing 3 having a lower fore-end plate 4, and an upper fore-end plate 5. The lock comprises two projecting members in the form of a rotatable trigger 8 and a sliding deadbolt 7. The movable body 1 is co-operable with a stationary body 11. The stationary body 11 carries a strike plate 12 running parallel to the lower fore-end 4. There is a strike box 13 to the rear of the strike plate 12. The strike-box 13 is horizontally aligned with the deadbolt 7. The strike plate 12 also has a cambered face which forms a ramp 14.

The rotatable trigger 8, the driver 9, the deadbolt 7 and other elements of the lock move forwards and backwards. The forward direction is when the elements move out of the lock casing 3, beyond the lower fore-end 4. The backwards direction is the opposite direction.

The rotatable trigger 8 comprises a rotatable planar form 15 and projections 16, 17. The projections 16, 17 are perpendicular to the planar form 15. The projections 16, 17 act to create a fulcrum column 18 of the rotational movement of the rotatable trigger 8. The projections 16, 17 sit in either of slots 19 in the lower fore-end 4 or can be rotated 180° such that the fulcrum column 18 sits in the opposite slot 19 in the lower fore-end 4, as shown in FIG. 3. The upper fore-end 5 sits over the lower fore-end 4 in order to hold the rotatable trigger 8 in position. The driver 9 slides forwards and backwards in slots in the casing 3. The driver 9 is spring projected forwards by compression of the second spring 10 in order to maintain a forward force on the rotatable trigger 8.

There is a first spring 20, a bolt link 21 and a spring arm 26, all of which are centrally mounted on a pivot 22. A first extension 23 of the bolt link 21 sits in a notch 24 in the driver 9. The first extension 23 moves with the driver 9 to rotate the bolt link 21. A second extension 25 of the bolt link 21 connects with the spring arm 26. The spring arm 26 also rotates on the pivot 22 and sits over the bolt link 21. The spring arm 26 has legs 28, 29 which slide over a pin 30 on the deadbolt 7 to move the deadbolt 7 forwards and backwards. The first spring 20 is in the form of a torsion spring and it sits over the spring arm 26. The first spring 20 pivots over the pivot 22. The first spring 20 has a leg 32 which sits into a notch in a projection 33 of the spring arm 26. The first spring 20 also has a leg 34 which sits in a notch 35 in the driver 9.

The rotatable trigger 8 may be handed (reversed in direction to accommodate a right hand opening movable body as opposed to a left hand opening movable body, or vice versa).

Referring to FIG. 3, the fulcrum column 18 of the rotatable trigger 8 is fitted into the fore-end 4. The slot 36 is located centrally of the slots 19. The rotatable trigger 8 is pressed back against the driver 9, such that projections 37, 38 of the rotatable trigger 8 fit through the slot 36 of the lower fore-end 4 first. Then the rotatable trigger 8 is shifted sideways to allow the fulcrum column 18 into one of the slots 19, with the projections 37, 38 sitting to the rear of the lower fore-end 4. The distance between the slots 19 is different to the distance between the projections 37, 38, and the central fulcrum column 18, such that when the fulcrum column 18 is in a slot 19, then the projections 37, 38 are maintained to the rear of the lower fore-end 4.

FIG. 2 is a plan of the lock including the rotatable trigger 8. FIG. 2 shows how the measurement indicated as “A” is less than the measurement indicated “>A”. When the rotatable trigger 8 meets the strike plate 12, the configuration of the strike plate ramp 14 is such that the point of contact between the rotatable trigger 8 and the strike plate 12 ensures that the furthest point 39 of the rotatable trigger 8 becomes the point upon which the closing force is directed. The dimensions of the rotatable trigger 8 are such that a mechanical advantage is derived from the configuration such as to reduce the movable body closing force.

The closing action of the lock shown in FIGS. 1-8 is as follows. The lock casing 3 is brought into contact with the strike plate 12 such that the rotatable trigger 8 is the first member to contact the ramp 14. As the rotatable trigger 8 contacts, it rotates into the lock casing 3, forcing the driver 9 backwards against the second spring 10. The driver 9 rotates the first spring 20, which rotates the spring arm 26, which drives the deadbolt 7 forwards out of the lock casing 3. The deadbolt 7 moved forwards to meet the ramp 14 of the strike plate 12, and as the movable body 1 closes, the deadbolt 7 slides along the ramp 14. As the movable body 1 is pressed further into the stationary body 11, the deadbolt 7 aligns with the strike box 13 and the deadbolt 7 projects into the strike box 13 to lock the movable body 1.

FIGS. 1-8 show a balanced action deadbolt lock with a rotatable trigger assembly within the mechanism. If the movable body 1 is free of the stationary body 11, the rotatable trigger 8 may be rotated by accident or intentionally and the deadbolt 7 will then project from the casing. However, f the force is removed from the rotatable trigger 8, the deadbolt 7 will retract backwards into the casing 3 again. The movement to force the deadbolt 7 out is as described above with reference to the movable body 1 locking, but without a strike plate. Thus, if the rotatable trigger 8 is released again, the second spring 10 will force the driver 9 forwards and rotate the rotatable trigger 8 out of the casing. This movement of the driver 9 will rotate the bolt link 21, with the extension 25 of the bolt link 21 contacting and rotate the spring arm 26 such that the legs 28, 29 of the bolt spring arm 26 will withdraw the deadbolt 7 back into the lock casing 3. This will thus correct the lock such that the lock is ready to lock again if brought into juxtaposition with the strike plate 12.

The assembly of the lock shown in FIGS. 1-8 illustrates how the lock includes a first spring 20 which is configured to limit the force required to pressure the first spring 20 such that, once sufficient spring tension has built up in the first spring 20 by backward movement of the driver 9, then a continued backward movement of the driver 9 will not continue to increase the spring tension. More specifically, the driver 9 is configured to slide over the first spring 20 in the latter stages of the backwards movement of the driver 9. FIG. 1 shows how the driver 9 will directly rotate the first spring 20 as the lock comes into contact with the strike plate 12. FIG. 4 shows the driver 9 still rotating the first spring 20 as the rotatable trigger 8 moves up the ramp 14 in a semi-movable body closure situation. FIG. 5 shows the driver 9 beginning to slide over the first spring 20 as the rotatable trigger 8 and the deadbolt 7 move into position in alignment with the strike box 13.

FIGS. 1 and 3-8 show a thrower 40. FIG. 4 shows that the thrower 40 includes curved projections 41. The curved projections 41 sit in curved slots in the casing 3, and they allow the thrower 40 to move radially about a user-operable mechanism 42. The user-operable mechanism 42 may be inserted into the lock casing 3 in order to operate the lock and may be interchangeable to the lock. A nib 43 of the user-operable mechanism 42 rotates the thrower 40 such that a face 44 of the thrower 40 meets a face 45 of the deadbolt 7, and thereby moves the deadbolt 7 backwards in the casing 3. A torsion spring 46 pivots on a barrel stump 47, and locates in a void 48 of the thrower 40. FIG. 7 shows the thrower 40 having unlocked the deadbolt 7 (shown dotted) and the torsion spring 46 in an extended state. If a user removes the force on the user-operable mechanism 42, the thrower 40 returns to its normal state as shown in FIGS. 1, 4 and 5, and thus the nib 43 will move with the thrower 40.

Referring to FIGS. 4 and 5, the thrower 40 and the spring 46 are configured to include for a volume of space situated between the barrel stump 47 and the thrower 40. A member such as a bolt 27 shown in FIG. 4 may optionally be inserted laterally through the casing 3, through a hole 49 shown in FIG. 5. Such a lateral projection may be necessary to fasten an escutcheon plate to the external side of a movable body. A second lateral projection may be fitted through area 50 of the lock casing 3.

FIGS. 6, 7 and 8 include the same lock mechanism as in previous figures, but also including additional members in the form of a tumbler 51 and a slider 52 which fit over the barrel stump 53. The tumbler 51 comprises a composite form and acts as a holdback facility to the deadbolt 7 when the lock is unlocked. The tumbler 51 includes a hooking face 54 which hooks over a face 55 of the deadbolt 7 to act as a holdback. The slider 52 moves up and down over the barrel stump 53. The projection 56 (see FIG. 8) of the slider 52 moves up and down in the slot 57 as best seen in FIG. 4. The slider 52 is operated by the thrower 40 during an unlocking cycle. The tumbler 51 includes a planar form 58 (see FIG. 7). The planar form 58 has a rounded edge 59 which is moved up and down by a face 60 of the slider 52 such that an up or down movement of the slider 52, rotates the tumbler 51. During an unlocking cycle, the face 61 of the thrower 40 raises the slider 52 up, thus rotatable the tumbler 51 upwards to allow the deadbolt face 62 to slide under the face 63 of the tumbler 51. In a movable body locked situation, the face 63 of the tumbler 51 falls onto the deadbolt 7 such that, if a force is put on the deadbolt 7 in order to retract it into the casing 3, the face 65 of the deadbolt 7 presses against the face 64 of the tumbler 51 and thus prevents the deadbolt 7 from retracting, and so acting as a deadlocking feature. The face 64 of tumbler 51 rotates in and out of a deadlocking position with face 65 of the deadbolt 7 (see FIG. 9). The tumbler 51 rotates about barrel stump 53 and with bolt link 21 connecting with tumbler 51 by projection 66 of bolt link 21 raising and lowering projection 67 of tumbler 51 as the bolt link 21 rotates forwards and backwards.

FIG. 8 illustrates a re-locking feature. More specifically, if the deadbolt 7 is unlocked and the tumbler 51 is engaged as a holdback facility thus allowing the force on the user-operable mechanism 42 to be released, the user has the option to disengage the holdback facility. This option is achieved by rotating the user-operable mechanism 42 in the opposite direction to the unlocking rotation. This allows the nib 43 to raise the face 66 of the slider 52, thus rotating the tumbler 51 to release the holdback facility and allow the deadbolt 7 to move forwards again to the locking position.

FIGS. 9-12 show a second lock of the present invention with similar parts as in the lock shown in FIGS. 1-8 and have been given the same reference numbers for ease of explanation and understanding. The second lock has an adapted spring arm 68. Also included is an unlocking assembly which includes unlocking cam 70 and unlocking barrel 71. Unlocking barrel 71 includes a square shaped void 72 such that a user operable mechanism, for example a door handle, may fit to rotate the unlocking assembly.

If the unlocking assembly is rotated by a user operated mechanism, projection 74 of unlocking barrel 71 raises slider 52 (see FIG. 10) to move deadlocking face 64 from the backwards direction of movement of face 65 of deadbolt 7. Projection 74 continues to rotate to meet projection 75 of unlocking cam 70 to rotate unlocking cam 70 and thus to rotate cam arm 69 to connect with adapted spring arm 68, rotating it to move deadbolt 7 into a semi-retracted position as in FIG. 10 and then to a fully retracted position whereupon the lock is unlocked.

FIG. 11 shows the second lock free of the strike plate. If the rotatable trigger 8 is rotated into the casing, the deadbolt 7 will move forwards to the projected position. If the rotatable trigger 8 is then released such that the deadbolt 7 is retracted into the lock casing 3, the deadbolt 7 may collide with the cam arm 69 which is free to rotate backwards such that it does not impede the movement of the deadbolt 7. Also shown is torsion spring 76 which brings the unlocking barrel 71 to its resting position (see FIG. 11).

It is to be appreciated that the embodiments of the invention described above with reference to the accompanying drawings have been given by way of example only and that modifications may be effected. Individual components shown in the drawings are not limited to use in their drawings and they may be used in other drawings and in all aspects of the invention. The invention also extends to the individual components mentioned and/or shown above, taken singly or in any combination.

1. A lock for securing to a movable body and for cooperating with a strike plate on a stationary body, which lock is movable away from the strike plate for opening the movable body, which lock is movable into juxtaposition with the strike plate for closing the movable body, and which lock comprises a casing which includes a rotatable trigger which is positioned in the casing and a locking member which is also positioned in the casing and wherein:
the rotatable trigger projects from the casing;
the rotatable trigger rotates about an axis of rotation positioned on a front working plane of the casing such that the rotatable trigger rotates into the casing and out of the casing with the rotatable trigger being spring biased to rotate out of the casing;
the locking member is movable between a projected position in which the locking member projects from the casing and a retracted position in which the locking member is retracted into the casing;
the locking member is configured to move into the projected position when the rotatable trigger rotates into the casing;
the locking member is configured to move into the retracted position when the rotatable trigger rotates out of the casing;
when the lock is brought into juxtaposition with the strike plate the rotatable trigger comes into juxtaposition with the strike plate such that the rotatable trigger rotates into the casing and the locking member moves into a locked position, whereby the locking member projects from the casing such that the locking member moves into a recess in the strike plate to lock the movable body; and
when the lock is moved out of juxtaposition with the strike plate the rotatable trigger rotates out of the casing and the locking member moves into the retracted position.

2. A lock according to claim 1 wherein the spring bias force which operates on the rotatable trigger to bias the rotatable trigger to rotate out of the casing, is such that the same spring bias force is also configured to force the locking member into the retracted position in the casing as the rotatable trigger rotates out of the casing, such that, when the lock is moved out of juxtaposition with the strike plate the rotatable trigger will be spring biased to rotate out of the casing and the locking member will be spring biased to move into the retracted position in the casing.

3. A lock according to claim 1 and including a tumbler in the casing and wherein:
the tumbler is configured such that as the rotatable trigger rotates into the casing and the locking member projects out of the casing into a partially or fully projected position, the tumbler moves into a position in the casing such that it prevents the locking member from being forced into the casing by a force external of the casing being applied to the projected end of the locking member; and
the tumbler is also configured such that when the rotatable trigger rotates out of the casing and the locking member moves into the unlocked position in the casing, the tumbler moves out of a position where it prevents the locking member moving into the unlocked position.

4. A lock according to claim 1 in which the locking member is a locking bolt such that the front projecting plane of the locking bolt is orthogonal in form.

5. A lock according to claim 1 and including a minimum angle of rotation of the rotatable trigger such that the minimum angle of rotation will achieve a full projection of the locking member such that:
when the lock comes into juxtaposition with the strike plate, there is a maximum gap distance between the front working plane of the casing and the corresponding face of the strike plate such as to allow for the minimum angle of rotation of the rotatable trigger to be achieved, and such that;
the maximum gap distance is a maximum measurement which still ensures a full projection of the locking member;
there is a projection distance, which is the distance the furthest point of the rotatable trigger projects beyond the front working plane of the casing when the rotatable trigger is fully rotated out of the casing; and
there is a relationship between the projection distance and the maximum gap distance such as to have a minimising effect on the required projection distance relative to the maximum gap distance.

6. A lock according to claim 1 and including a first spring in the casing which acts between the rotatable trigger and the locking member and in which:
the first spring is configured such that as the rotatable trigger comes into juxtaposition with the strike plate, the rotatable trigger rotates into the casing such that a force is applied to the first spring which applies a force to the locking member to move the locking member out of the casing; and
the force applied to the locking member gradually increases as the rotatable trigger rotates into the casing.

7. A lock according to claim 6 in which the force applied to the first spring increases as the rotatable trigger rotates into the casing and the first spring is further configured to act between the rotatable trigger and the locking member such as to reduce the force required to rotate the rotatable trigger during the latter stages of rotation of the rotatable trigger into the casing.

8. A lock according to claim 6 and including a driver and a second spring, and in which:
the driver is positioned behind the rotatable trigger such that the driver is forced backwards by the rotatable trigger into the casing by the engagement of the rotatable trigger with the strike plate; and
the driver being biased by the second spring in a forward direction to remain in contact with the rotatable trigger, thereby biasing the rotatable trigger to project from the casing;
the first spring is configured with the driver such that the backwards movement of the driver applies a force to the first spring which is configured to apply a force to the locking member to move the locking member to the projected position; and
the driver is configured with the locking member such that if the lock is moved out of juxtaposition with the strike plate, the second spring biases the driver in a forwards direction which spring biases the locking member into a retracted position in the casing.

9. A lock according to claim 8 and including a bolt link which rotates about a fixed fulcrum in the casing, and a spring arm which also rotates about the fixed fulcrum, and in which:
the rotation of the spring arm is such as to move the locking member between the projected position out of the casing and the retracted position into the casing;
the first spring is configured with the driver such that the backwards movement of the driver is configured to apply a force to the first spring which applies a force to the spring arm to rotate the spring arm to cause the locking member to move to the projected position;
the driver is configured with the bolt link such that a movement of the driver causes a rotation of the bolt link;
as the lock is moved out of juxtaposition with the strike plate and the rotating trigger rotates out of the casing, the driver is spring biased forwards by the second spring; and
the bolt link is configured with the spring arm such that a forwards movement of the driver causes a rotation of the bolt link which causes a rotation of the spring arm to move the locking member into the retracted position.

10. A lock according to claim 9 in which the first spring is a torsion spring which rotates about the fixed fulcrum, the first spring has a first leg and a second leg, the first leg is configured to move with the driver, the first leg is rotatable by the driver as the driver moves backwards in the casing and thereby to apply force to the second leg which is configured to put a rotational force on the spring arm to move the locking member to the projected position.

11. A lock according to claim 8 in which the first spring and the driver are configured such that when the driver is in the latter stages of its backwards movement, the driver slides over the first leg of the first spring, thus reducing the force required to rotate the rotatable trigger in the latter stages of its rotation into the casing.

12. A lock according to claim 9 in which the tumbler is configured such that the rotation of the bolt link moves the tumbler into a position in the casing that prevents the locking member from being retracted into the casing by a force applied to the projected area of the locking member, and the tumbler also being configured such that the opposite rotation of the bolt link moves the tumbler out of a position where the tumbler prevents the locking member moving into the unlocked position.

13. A lock according to claim 8 in which the rotatable trigger is configured to engage the strike plate, and the rotatable trigger rotates about a point of rotation, and in which:
the distance between the point of rotation and the point of contact of the rotatable trigger with the strike plate, is greater than the distance from the point of rotation to the contact point of the rotatable trigger with the driver, thereby creating a mechanical advantage to reduce the lateral force required to rotate the rotatable trigger against the strike plate to achieve a backwards movement of the driver during closure of the movable body.

14. A lock according to claim 1 and including a thrower in the casing and a thrower spring which is in the casing and which is connected to the thrower, and a user-operable mechanism which is interchangeable to the casing, and in which:
the user-operable mechanism is able to exert a force that moves the locking member from the locked position to the unlocked position;
the user-operable mechanism has a rotatable nib which is movable in an arc within the casing;
the thrower is movable in an arc within the casing, the arc being approximately concentric to the arc described by the rotatable nib;
the thrower spring is a torsion spring with one leg of the thrower spring mounted on a pivot in the casing and the other leg of the thrower spring pivoted on the thrower such that;
when a force is applied to the rotatable nib, the rotatable nib moves the thrower, the thrower being spring biased by the thrower spring so that when the force on the rotatable nib is released, the rotatable nib is spring biased to return to its original position prior to a force being applied to it; and
the thrower is configured to move the locking member to the unlocked position.

15. A lock according to claim 1 and including an unlocking assembly which rotates in the casing to move the locking member to the unlocked position when an unlocking force is applied to the unlocking assembly and the unlocking assembly is configured to reduce the rotation required of the unlocking assembly to move the locking member to the unlocked position wherein a projecting member of the unlocking assembly moves the locking member to the unlocked position, and in which:
the unlocking assembly includes an unlocking barrel and an unlocking cam, with the unlocking cam acting as the projecting member of the unlocking assembly;
the unlocking cam is rotatable with the unlocking barrel, the unlocking barrel being rotatable to connect with the unlocking cam thus rotating the unlocking cam to move the locking member to the unlocked position; and
when the locking member is positioned in the casing where the locking member may be in collision with the unlocking cam during a retraction of the locking member into the casing when the lock is free of the strike plate, the unlocking cam is configured to freely rotate during such a collision such as not to prevent the movement of the locking member into the retracted position.
